(19) United States
(12) Patent Application Publication
(10) Pub. No.: US 2015/0147453 A1
(43) Pub. Date: May 28, 2015

(54) System and Method for Forming A Food Product With A Solidified Liquid Additive

(71) Applicant: The Hillshire Brands Company, Chicago, IL (US)

(72) Inventor: Joshua S. Carlson, Glen Ellyn, IL (US)

(73) Assignee: The Hillshire Brands Company, Chicago, IL (US)

(21) Appl. No.: 14/567,020

(22) Filed: Dec. 11, 2014

Related U.S. Application Data
(62) Division of application No. 12/887,055, filed on Sep. 21, 2010.
(60) Provisional application No. 61/244,700, filed on Sep. 22, 2009.

(51) Int. Cl. A23L 1/22; A23L 1/00

(52) U.S. Cl. CPC A23L 1/22016; A23L 1/0079; A23V 2002/00
USPC 426/573

(57) ABSTRACT

A food product includes a base component; one or more solid additive pieces, each solid additive piece comprising an additive and a binder; and a casing containing the base component and the one or more solid additive pieces; wherein the additive is a liquid at room temperature.

### CROSS-REFERENCE TO RELATED PATENT APPLICATIONS

This application is a divisional of and claims priority benefit of U.S. application Ser. No. 12/887,055 filed 21 Sep. 2010, which itself claims priority benefit to U.S. Provisional Application No. 61/244,700, filed 22 Sep. 2009, both of which are incorporated by reference herein in their entirety.

### BACKGROUND

The present disclosure relates generally to the field of making a food product with an additive included with other ingredients. More specifically, the present disclosure relates to a food product that includes a solid or semi-solid liquid additive (e.g., condiment, or a supplemental or complementary food item) as an ingredient.

It is generally known to serve condiments with various food products. Such condiments/food products may include ketchup, mustard, BBQ sauce, or the like, served with or applied to hot dogs, brats, or other “formed” food products made from various ingredients. It is also known to manufacture such food products by combining ingredients as a physical mixture as opposed to a chemical mixture. In a chemical mixture, the ingredients cannot be separated or “unmixed.” An example of a physical mixture is a sausage that includes meat and other ingredients enclosed in a casing.

It would be advantageous to provide a food product that has the condiments already included as an ingredient in a form that is stable and able to be included as one of many ingredients (e.g., rather than needing to be co-extruded or otherwise injected). Such a product provides convenience and portability to a variety of different types of food products in a variety of end use settings. To provide an inexpensive, reliable, and widely adaptable food product with a solidified liquid additive (e.g., condiment, etc.) provided as an ingredient would represent a significant advance in the art.

### SUMMARY

One embodiment relates to a food product comprising a base component; one or more solid additive pieces, each solid additive piece comprising an additive and a binder; and a casing containing the base component and the one or more solid additive pieces; wherein the additive is a liquid at room temperature.

Another embodiment relates to a method for making a food product, the method comprising providing a base component, a first liquid additive, and a binder; combining the first liquid additive and the binder to solidify the first liquid additive; dividing the solidified first liquid additive into a plurality of first additive pieces; combining the first additive pieces with the base component to form a mixture; and forming the mixture into a desired food product configuration.

Another embodiment relates to a food product, comprising a physical mixture, the physical mixture comprising a base component and a plurality of additive pieces, each additive piece comprising an additive and a binder; and a casing containing the mixture; wherein the additive is a liquid at room temperature and the binder is configured to provide the additive pieces as a solid or semi-solid at room temperature.

The present disclosure further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### BRIEF DESCRIPTION OF THE DRAWINGS

FIG. 1 is a schematic cross-section illustration of a food product according to an exemplary embodiment.

FIG. 2 is a schematic illustration of a system for making the food product of FIG. 1 according to an exemplary embodiment.

FIG. 3 is a flow diagram of a method of making a food product according to an exemplary embodiment.

FIG. 4 is a flow diagram of a method of making a food product according to a known embodiment.

FIG. 5 is a flow diagram of a method of making a food product according to an exemplary embodiment.

FIG. 6 is a flow diagram of a method of making a food product according to an exemplary embodiment.

FIG. 7 is a flow diagram of a method of making a food product according to an exemplary embodiment.

### DETAILED DESCRIPTION

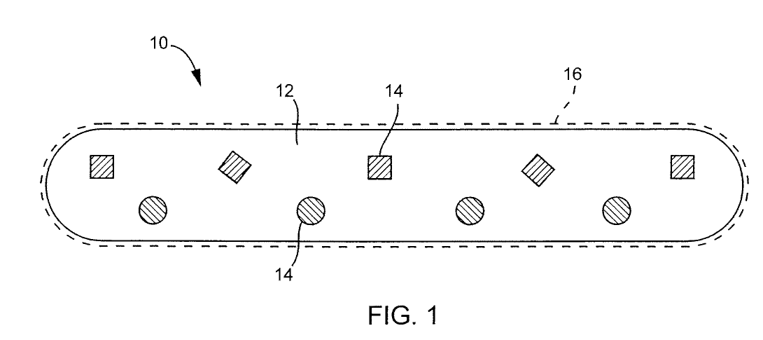

Referring to FIG. 1, a section view of a food product 10 is shown according to an exemplary embodiment. Food product 10 includes a variety of ingredients, including (but not limited to) a base ingredient 12 and one or more additive pieces 14. Food product 10 may include any of a variety of products where it is desirable to provide one or more additives in combination with a base ingredient. Food product 10 may also include a casing 16 that encloses base ingredient 12 and additive pieces 14. However, it should be understood that the embodiments herein may extend to various food products that do not include a casing such as casing 16, or where casings are not required after the food product is cooked. Such food products may include, for example, skinless hotdogs (e.g., where the hot dogs are cooked in water and the casing removed prior to sale to consumers), and restructured /chunked/formed food products such as ham, roast beef, chicken, turkey, etc. (e.g., where the product may be cooked in a bag, form, casing, and the like).

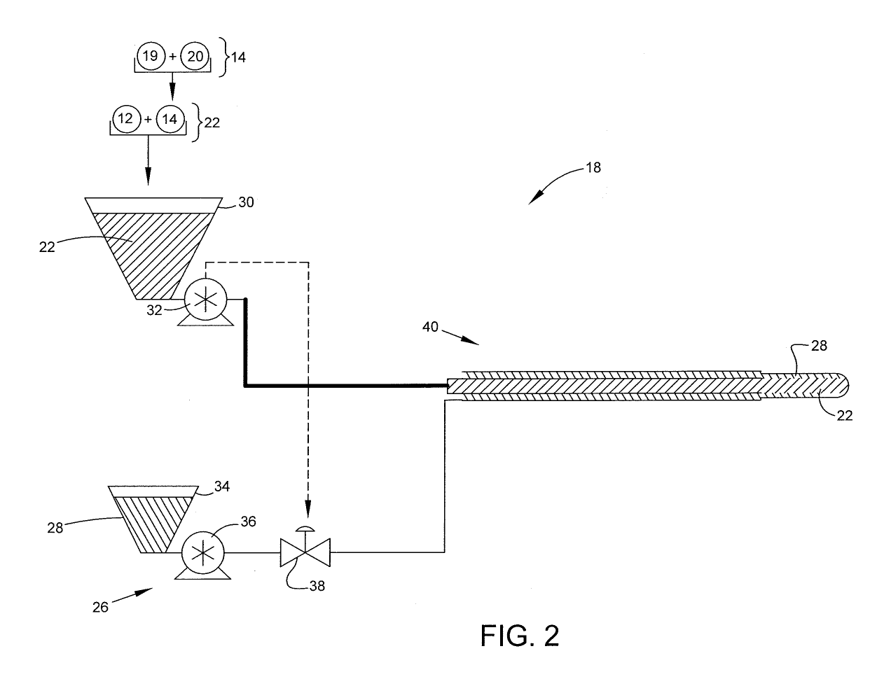

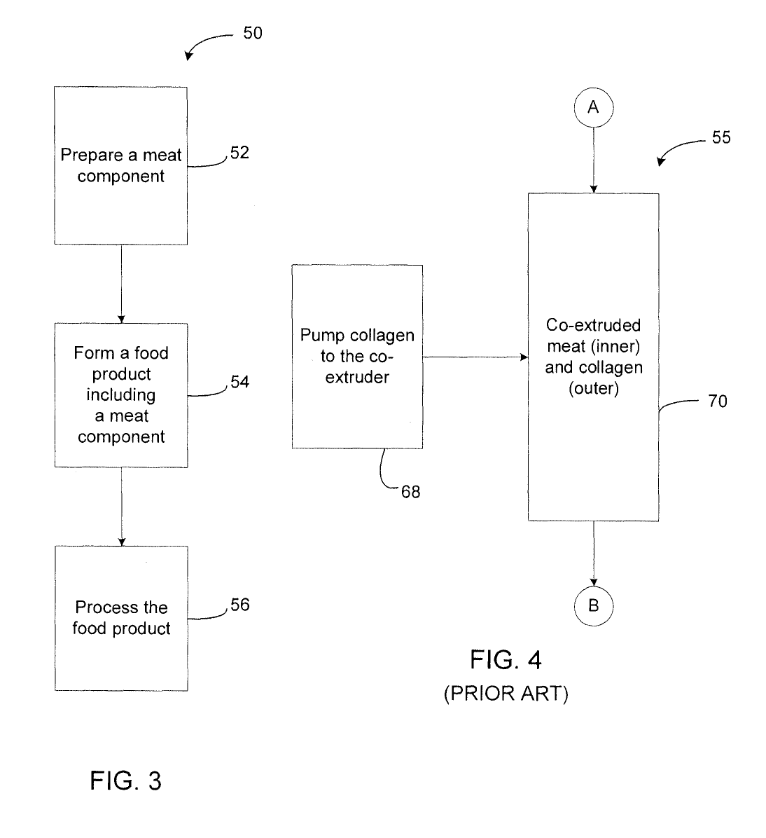

According to an exemplary embodiment, food product 10 is made (e.g., formed, manufactured, etc.) as a physical mixture of ingredients such as base ingredient 12 and additive pieces 14. FIG. 2 shows an exemplary system 18 for making food product 10, and FIGS. 3-6 show exemplary flow diagram processes for making food product 10.

Base ingredient 12 forms the primary volume and flavor of food product 10. Examples of base ingredient 12 include a variety of meats (e.g., beef, pork, chicken, lamb/sheep, fish, or other red or white meats), protein-based food products, and a variety of other food products where it may be desirable to include one or more additives.

Each additive piece 14 comprises an additive 19 that is typically a liquid at room temperature. Additive 19 is provided with a solidifying agent, such as a thermally reversible binder 20 (e.g., gelling agent, stabilizer, firming agent, etc.). Binder 20 is configured to solidify the otherwise liquid additive 19 (e.g., render to a non-liquid/fluid condition). Binder 20 is also configured to allow additive pieces 14 to become liquid again when heated (e.g., when being cooked or heated prior to consumption). According to an exemplary embodiment, additive 19 is a condiment (e.g., ketchup, mustard, BBQ sauce, relish, mayonnaise, honey, jelly/jam, etc.) or other flavorings or food components intended to supplement or complement base ingredient 12 (e.g., syrup, wine, beer, juice, cheese, etc.). Food product 10 may have a single type of additive (e.g., in the case of a hot dog with just mustard) or have two or more different types of additives (e.g., in the case of a hot dog with ketchup and mustard).

According to an exemplary embodiment, binder 20 comprises a gelatin, starch, gum, alginate, or other material that solidifies liquid additive 19. After being solidified by binder 20, additive pieces 14 may be divided (e.g., cut, sliced, chopped, diced, etc.) into a variety of shapes and sizes, such as cubes, balls/spheres, strips, or the like.

Referring to FIGS. 1 and 2, additive pieces 14 are fanned by mixing additive 19 with binder 20. According to an exemplary embodiment, the additive/binder blend or mixture is preferably a solid at room temperature so that it may be stored, transported, and otherwise handled throughout the manufacturing process. Alternatively, the additive/binder blend remains a liquid after food product 10 is heated by the consumer (e.g., undergoes a particular type of heating process, a particular number of heating processes (e.g., one, two, etc.). Additive 19 and binder 20 combine to form additive piece(s) 14. Solidified additive piece 14 is then mixed or combined with the other ingredients in food product 10 (e.g., base ingredient 12 such as a meat, non-meat, etc.) to form blend 22. When food product 10 is heated (e.g., prior to consumption), solidified additive piece 14 reverts to a liquid due to the heat. As a liquid, additive 19 is in the form that the consumer expects to encounter.

In some embodiments, additive 19 may undergo one or more phase changes between solid/semi-solid/liquid states. The temperature of each phase change may depend on a variety of factors (e.g., binder/stabilizer, soluble solids, levels of binders, etc.). For example, if a hot dog is stored in a refrigerator (e.g., 38 degrees F.), the mustard and/or ketchup additive pieces may be in solid form, such that when heated (e.g., grilled, microwaved, boiled, etc.) to 100-170 degrees F., the mustard and/or ketchup additive pieces liquefy and provide condiment flavoring to the consumer.

According to one embodiment, casing 16 (if provided) is configured to contain base component 12 and additive pieces 14. Casing 16 may be formed by a coagulated collagen gel. Alternatively, casing 16 may be any of a variety of natural or synthetic materials that provide the desired containment, texture, and taste.

FIG. 2 shows a schematic representation of a system 18 for manufacturing food product 10 according to an exemplary embodiment. System 18 is configured to combine and mix base component 12 with additive pieces 14 to provide a desirable taste, flavoring, appearance, color, texture, aroma, or the like. According to alternative embodiments, the system and method may be used to manufacture food products, such as food products without a collagen layer (e.g., skinless, natural casing, etc.) such as casing 16.

System 18 includes a supply line 24 for base component 12/additive pieces 14 and a supply line 26 for a collagen layer 28 (which may be used to form casing 16). Supply line 24 includes a hopper 30 and a positive displacement pump 32. Supply line 24 is maintained at a predetermined temperature in the hopper, pumping, extrusion, and packaging processes so that additive pieces 14 do not soften or liquefy during the manufacturing process and remain in solid or semi-solid form. Base component 12 and additive pieces 14 are blended together to form blend 22 and delivered to hopper 30. Supply line 26 for collagen layer 28 includes a hopper 34, a positive displacement pump 36, and a control valve 38. Control valve 38 is operated (e.g., by a controller or control system) based on the volume of blend 22 being pumped by pump 32. Blend 22 is then pumped through a dual horn system 40 with blend 22 in the center and collagen 28 around the exterior of blend 22. Collagen 28 solidifies or sets in later steps to form casing 16 surrounding blend 22. Food product 10 then progresses to other operations as required for the specific food product (e.g., cooking, partially cooking, slicing, packaging, etc.).

Referring now to FIG. 3, schematic block flow diagram of an exemplary system and process 50 for manufacturing food product 10 (e.g., sausage, links, etc.) is shown. According to an exemplary embodiment, a meat (or non-meat) base material (e.g., a “dough” or blend) is first prepared (step 52). The prepared meat base material is then provided (e.g., fed, conveyed, etc.) to an apparatus such as a co-extrusion machine. The co-extrusion machine extrudes the meat base material and other materials, including a collagen gel, to form a food product such as a co-extruded rope or strand (step 54). The co-extrusion machine includes an extrusion head with a plurality of openings for the various extruded components (e.g., an inner hole for the base component and an annular opening for the collagen gel). After the co-extrusion machine forms the food product, the food product is processed and packaged (step 56).

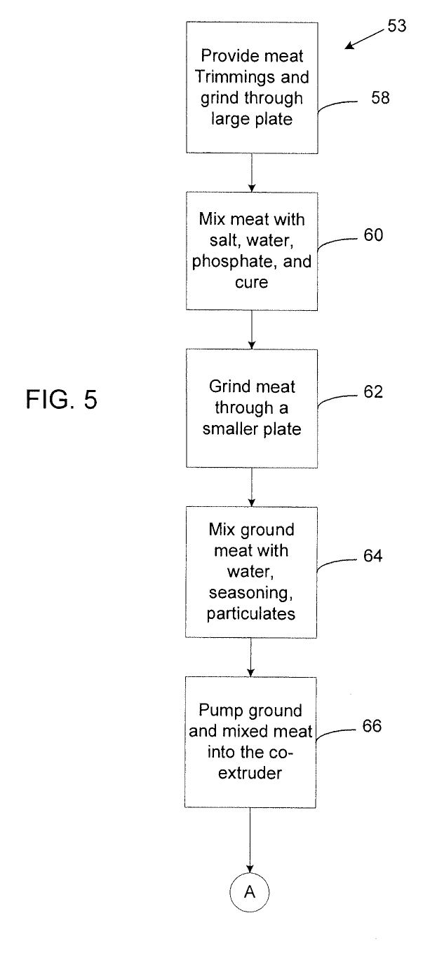

Referring to FIG. 5, an exemplary method 53 of preparing a meat base material is illustrated. According to alternative embodiments, the system and method may be used to manufacture food products, such as food products without a collagen layer (e.g., skinless, natural casing, etc.). Meat trimming or other food materials are ground through a large grinder plate to form a coarsely ground base (step 58). The ground meat is then mixed with additives such as salt, water, and phosphate and is allowed to cure for a period of time (e.g., overnight (step 60)). The blended meat is ground through a smaller grinder plate (step 62). The coarsely ground meat is blended with additional products such as water, seasonings, and other particulates (step 64). The blended meat is provided to the co-extrusion machine as a meat component for the food product (step 66).

Referring to FIG. 4, an exemplary prior art method 55 for forming a food product is illustrated. Collagen is pumped to the co-extruder (step 68). The co-extrusion machine extrudes the base component and the collagen gel material on the outer surface of the base material to form a co-extruded rope or strand (step 70). The co-extrusion machine may have one or more extrusion heads to provide single, dual, etc. co-extruded ropes. The collagen gel applied to the outer surface of the meat is then solidified (i.e., coagulated) by subsequent operations to provide a casing (e.g., encasement, skin, etc.) for the meat base material.

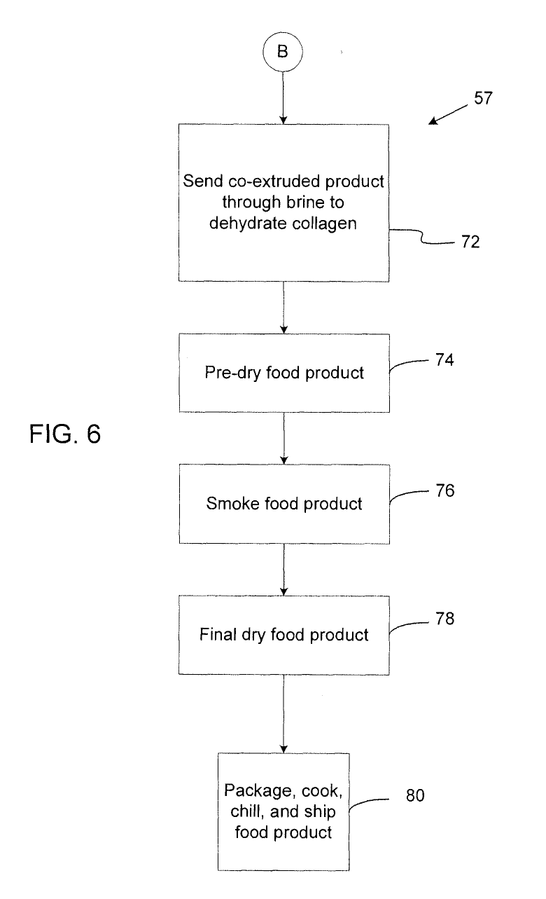

Referring to FIG. 6, an exemplary method 57 for processing a food product is illustrated. According to an exemplary embodiment, the co-extruded rope from the co-extrusion machine is conveyed to an apparatus (e.g., a brining unit) to transform (e.g., coagulate, solidify, etc.) the collagen gel into a casing that surrounds the meat blend (step 72). The brining step is intended to firm or strengthen the collagen gel coating sufficiently for additional manufacturing processes. To form the casing, the brining unit subjects the co-extruded rope to a solution that removes water content from the collagen gel. According to an exemplary embodiment, the solution is a brine salt, such as sodium chloride. According to other embodiments, the solution may be any of a variety of different salts or solutions that remove water from the collagen gel.

After the collagen gel is at least partially coagulated, the continuous co-extruded strand of meat blend and collagen gel may be conveyed to a crimper. The crimper forms the continuous strand into segmented portions or links in a pinching operation and separates the links. This exemplary embodiment provides a strand of links. Alternatively, this process may be used to provide a continuous or unsegmented food product or a process including a slicer that replaces the crimper to provide separate food products.

The separated links are then conveyed to a pre-dry zone where heat is applied to the links to further coagulate the collagen gel and to raise the core temperature of the links to partially cook the meat (step 74). Further coagulation of the collagen continues the process of increasing the strength of the casing by removing additional water content from the collagen gel (which by now has been partially coagulated/solidified). The brining step heat shrinks the gel down to a skin layer.

After the collagen gel is further coagulated by the heat in the pre-dry zone, the links are conveyed to an apparatus (e.g., a “liquid smoke zone”) to set the collagen (step 76). In the liquid smoke zone, a material is applied to the links to set or “cross-link” fibers of the collagen so that the collagen layer will not re-absorb water and return to a gel state or condition. The cross-linking material may be applied by any of a variety of conventionally known methods, such as spraying, pouring, deluging, bathing, emersion, or the like. The cross-linking material is conventionally referred to as “liquid smoke” due to its acid content and presence of aldehydes, but may be any of a variety of natural or synthetic chemicals that cross-links the fibers of the collagen (e.g., food grade or otherwise allowed by the Food and Drug Administration (FDA) or the U.S. Department of Agriculture (USDA). The cross-linking material may also be configured to be flavorless or to provide a desired flavor (e.g., smoke, etc.).

After the liquid smoke is applied, the links are conveyed to an apparatus for further heating to be final dried (e.g., a post-dry zone) to further partially cook the meat blend, to further dry the gel, and to dry the liquid smoke (step 78). Drying of the liquid smoke sets the flavor and color of the liquid smoke and prevents the liquid smoke from being washed away in subsequent operations. After the post-dry zone, the links may be conveyed to a water spray apparatus to rinse residue and non-set liquid smoke.

Referring further to FIG. 6, after the drying and smoking processes, the links are conveyed to a packaging apparatus. In one embodiment, the packaging apparatus packages the links in a thermoplastic material in a vacuum atmosphere such that the thermoplastic material provides a desired seal, tightly conforms to the links, and any air is removed from inside of the packaging (step 80). Such packaging is intended to minimize potential exposure to oxygen, moisture, and contaminants, and to facilitate the cooking process by eliminating space between the exterior of the packaging and the links to enhance conduction of heat energy. According to alternative embodiments, the links may be packaged by any of a variety of conventional machines in a variety of packaging configurations and materials.

The packaged links are then conveyed to an apparatus (e.g., water cook zone) that completes the cooking cycle (e.g., provides a packaged link that is fully cooked). According to an exemplary embodiment, the packaged links are submerged in water heated to a predetermined temperature for a predetermined amount of time. Alternatively, the packaged links are subject to heated water by any of a variety of means (e.g., spraying, pouring, deluging, or the like). The temperature of the water and the time that the packaged links are submerged will vary depending on the number of links, the formulation and size of each link, and the like. Completing the cooking process in the packaging is intended to reduce the potential for contamination of the food product, which may occur if the food product is fully cooked prior to being packaged. Such cooking also extends the shelf life of the food product without having to use preservatives. Alternatively, the packaged links may be partially cooked.

The cooked links are then conveyed to an apparatus to cool the heated links (e.g., a water chiller zone). According to an exemplary embodiment, the links are subjected to chilled water (e.g., spraying, pouring, deluging, bathing, emersion, etc.) that lowers the core temperature of the links to a temperature at a rate designated by regulations of the USDA or other entities.

During the cooking process, additive pieces 14 will liquefy due to the elevated temperatures. After the cooking steps, the temperature of food product 12 decreases, and the additive pieces 14 may re-solidify, become semi-solid, stay liquid, etc. (depending on the application). Some (or all if desired) of additive 19 may be absorbed into base component 12.

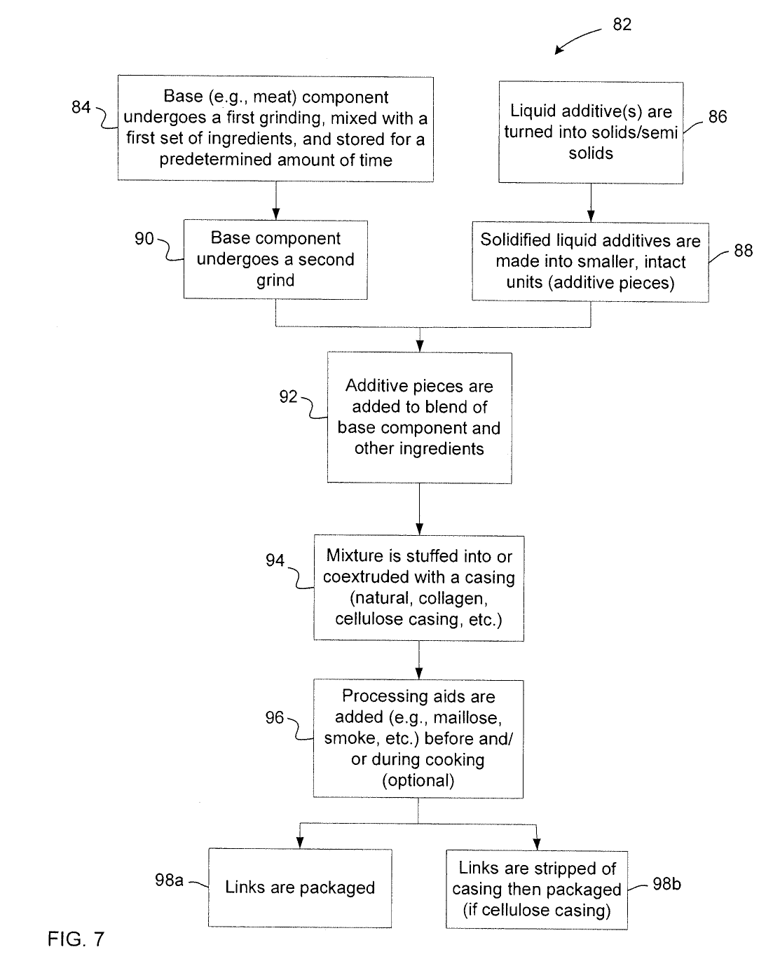

Referring to FIG. 7, a flow diagram of an exemplary process 82 for implementing the additive in another food product application is illustrated. In this embodiment, food product 10 is either sold with a natural casing or without a casing (e.g., skinless). In process 82, base component 12 (e.g., meat or other food product) undergoes a first grinding, is mixed with a first set of ingredients, and stored for a predetermined amount of time (step 84). Also, additive 19 is turned into solid or semi-solid by being combined with binder 20 (step 86). The solidified additive is then made into smaller, intact units (additive pieces 14) (step 88). Base component 12 may undergo a second grind (step 90). Additive pieces 14 are then added to the blend of base component 12 and other ingredients (step 92). The mixture is stuffed into a casing (e.g., a natural casing, a collagen casing, etc.) (step 94). Processing aids may then be added (e.g., maillose, smoke, etc.) before and/or during cooking (step 96). If a natural casing, the food product is packaged (step 98a). If a skinless product, the casing is removed (step 98b).

As shown in FIG. 7 and discussed elsewhere herein, according to various embodiments, food products such as food product 10 may be made by first preparing a base component such as a meat, adding one or more solidified additives to the base component such that the additives are dispersed throughout the base component, and then further processing the base component and additives (e.g., extruding, cooking, etc., utilizing a casing, bag, mold, form, water, etc.). The food products may be sliced, chunked, rebagged, etc. as a final processing step to suit a particular type of food product.

As used in this description, “food product” or “prepared foods” includes whole, ground, blended, and/or emulsified protein based products (e.g., meat, non-meat such as soy, etc.) in a variety of forms such as links or rings (e.g., sausage, bratwurst, hot dogs, wieners, meatloaf, loaf, meatballs, etc. with or without a collagen or non-collagen casing), logs, or other divisions. The system and process are directed to co-extruding food components to manufacture a food product.

One embodiment relates to a food product comprising a base component; and one or more solid additive pieces. Each solid additive comprises an additive and a binder (e.g., stabilizer, firming agent, etc.). The additive is a liquid at room temperature.

Another embodiment relates to a process for making a food product. The process comprises providing a base component, a first liquid additive, and a binder; combining the first liquid additive and the binder to solidify the first liquid additive; dividing the solidified first liquid additive into a plurality of first additive pieces; combining the first additive pieces with the base component to form a mixture; and forming the mixture into a desired food product configuration.

It is important to note that the construction and arrangement of the elements of the food product with a solidified liquid additive (e.g., condiment) as shown in the exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. Accordingly, all such modifications are intended to be included within the scope of the present disclosure as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the exemplary embodiments without departing from the spirit of the present disclosure as expressed in the appended claims.

What is claimed is:

1. A method for making a food product, the method comprising:
providing a base component, a liquid first additive, and a binder;
combining the liquid first additive and the binder to solidify the first additive;
dividing the solidified first additive into a plurality of first additive pieces;
combining the first additive pieces with the base component to form a mixture;
forming the mixture into a portion.

2. The method of claim 10 further comprising:
providing a liquid second additive;
combining the liquid second additive with the binder to solidify the second additive;
dividing the solidified second additive into a plurality of second additive pieces; and
combining the second additive pieces with the base component and the first additive pieces.

3. The method of claim 10, wherein forming the mixture into a portion comprises extruding the mixture into elongated segments.

4. The method of claim 3, wherein forming the mixture into a portion comprises co-extruding a collagen gel with the mixture, the collagen gel forming a casing containing the mixture.

5. The method of claim 4, further comprising packaging and at least partially cooking the portion.

6. The method of claim 1, wherein the binder comprises a thermally reversible gelling agent.

7. The method of claim 1, wherein the base component comprises a protein.
